(19) United States
(12) Patent Application Publication
(10) Pub. No.: US 2022/0227052 A1
(43) Pub. Date: Jul. 21, 2022

(54) IN SITU DEPOSITION DEBINDING AND SINTERING OR MELTING OF STRATEGICALLY DEPOSITED MEDIA FOR AN IMPROVED ADDITIVE MANUFACTURING PROCESS

(71) Applicant: Mark L. Jaster, Rigby, ID (US)

(72) Inventor: Mark L. Jaster, Rigby, ID (US)

(21) Appl. No.: 17/580,349

(22) Filed: Jan. 20, 2022

Related U.S. Application Data
(60) Provisional application No. 63/139,376, filed on Jan. 20, 2021.

(51) Int. Cl. B29C 64/295; B29C 64/268; B29C 64/165; B29C 64/371; B29C 64/386

(52) U.S. Cl. CPC B29C 64/295; B29C 64/268; B33Y 10/00; B29C 64/371; B29C 64/386; B29C 64/165

(57) ABSTRACT

The present invention combines three steps of the Bound Powder Deposition (BPD) process into a single real-time Additive Manufacturing (AM) process to improve print properties while decreasing both manufacturing times and associated costs.

### CROSS-REFERENCE TO RELATED APPLICATIONS

This application claims the benefit of U.S Provisional Patent Application No. 63/139,376 filed on Jan. 20, 2021; which is herein incorporated by reference in entirety.

### COPYRIGHT STATEMENT

A portion of this patent application document contains material that is subject to copyright protection including the drawings. The copyright owner has no objection to the facsimile reproduction by anyone of the patent document or the patent disclosure as it appears in the Patent and Trademark Office file or records, but otherwise reserves all copyright rights whatsoever.

### FIELD OF THE INVENTION

The present invention relates generally to customized fabrication and particularly to additive material fabrication of parts.

### BACKGROUND

Additive Manufacturing (AM) also known as 3D-Printing, printing or additive material fabrication is a field of manufacturing capable of manufacturing both simple and highly customized complex parts one layer at a time. Currently Additive Manufacturing processes can be broken down into seven families according to the ASTM F2792 Standards (American Society for Testing and Materials). Each family differs in the method by which material is applied and solidified throughout the additive manufacturing process.

Specific strengths and limitations exist between each family. Specific weaknesses in four of these families as they relate to metal additive manufacturing namely, Directed Energy Deposition (DED), Powder Bed Fusion (PBF), Binder Jetting (BJ), and Material Extrusion (ME) processes are addressed by this invention. The present embodiments and concepts improve upon the Bound Powder Deposition (BPD) process in the ME family known in the industry by the trade name of Bound Metal Deposition BMD™ or Bound Filament Fabrication.

### SUMMARY

In one embodiment an additive manufacturing process method comprises the steps of: depositing on a surface, using a depositing head, a first layer of a bound composite material comprised of a primary and a possible secondary binding components and a base component; thermally removing, using a directed heating device, at least 50% of the primary and a possible secondary binding components from the deposited composite material; depositing on the first layer, using the depositing head, a second layer of the compositing material; and thermally removing, using a directed heating device, at least 50% of the primary and a possible secondary binding components from the deposited composite material of the second layer.

The directed heating device can be configured to follow the path of the deposited composite material for each layer deposited thereafter. The directed heating device can be comprised of a laser, heating coil or solid-state device. This device can be directly connected to the depositing head or be mounted and manipulated through a secondary mounting and manipulation system. The directed heating device can be positioned to heat the laid down composite layer within seconds to minutes of material being laid down. In some variations, where the depositing head and the directed heating device are connected to the same mechanical manipulating mount, the directed heating device can direct targeted energy in the form of electromagnetic waves at an offset from the material just being laid. For example, a 5 mm offset, where the directed heating device is beginning to thermally remove (through a de-binding process) that causes the primary and possible secondary binding components to sublimate.

The additive manufacturing process can further comprise the step of melting or sintering the remaining base component of each deposited layer after each step of thermally removing at least 50% of the binding components is performed. This step can also be performed by the same directed heating device. The directed heating device can use a first temperature and settings for the thermally removing process and a second temperature and settings for the melting or sintering process. For example, a first wavelength or band of wavelengths can be used for the primary binding component at a first power level, while a second wavelength or band of wavelengths can be used for the melting or sintering process at a second power level. It should be noted that the settings will be different for melting and sintering.

The base component of the composite material can be comprised of one of the following: powdered metal, powdered ceramic, metal fibers, and ceramic fibers, while the primary and possible secondary binding component(s) can include a wide variety of polymeric, organic, and inorganic components, where the temperature or energy required to achieve sublimation is less than that of the base material. The primary binding component also has a melting or decomposition temperature below that of the base component. The base component can also form greater than 85% by weight of the bound composite material.

During this additive manufacturing process there is a further step of drawing away gas and particles generated from the thermally removing steps, using a gas and particle ventilation system, which in some instances can apply a vacuum force and create a vacuum environment. This environment can be aided by enclosing the build area. It should also be noted that the enclosed build area/volume can be deprived of greater than 95% oxygen, where the remaining gas is argon, nitrogen or another inert gas mixture.

During the step of melting or sintering the remaining base component of each deposited layer after each step of thermally removing at least 50% of the primary and possible secondary binding component is performed, the first layer and second layer can shrink in size less than 20% by volume.

The depositing head can be configured to be heated which helps the bound composite material to be extruded through the depositing head and precisely positioned.

The additive manufacturing process method can further comprise the step of sensing, using a non-contact temperature sensor, the temperature of the first layer prior to thermally preheating or removing material. The output of the directed heating device can be based on the measured temperate acquired from the non-contact temperature sensor, for each layer, and prior to de-binding, melting or sintering. This measured temperature can also be used to preheat a surface prior to laying a new layer down. The temperature sensor can be used in a real-time feedback loop during any of the above heating processes.

In another embodiment an additive manufacturing system comprises: a heated deposition head configured to precisely position on a build surface layers of a bound composite material formed of a primary binding component and a base material, wherein the heated deposition head is part of a 3-D printing system; a directed heating element that is configured to follow the path of the deposited bound composite material and wherein the directed heating element has at least two heating settings, a first heat setting configured to thermally remove the primary and possible secondary binding component(s) from the deposited bound composite material and a second heat setting configured to melt or sinter the remaining base material; a controller configured to operate the heated deposition head and the directed heating element, wherein the controller is configured to receive instructions to build a component using the bound composite material, wherein the instructions include the speed and placement of the materials for the depositing head, as well as the speed and temperature setting for the directed heating element; and an atmospheric controlled vacuum exhaust system.

This additive manufacturing system can further include an enclosure disposed about the build surface, wherein the enclosure is configured to receive from an atmospheric control manifold a gas used during a de-binding phase where the directed heating element is operating at a first temperature setting as well as during a melting or sintering phase where the directed heating element is operating a second temperature.

In yet another embodiment, an additive manufacturing method comprising the steps of: depositing on a surface, using a heated depositing head, a first layer of a polymeric material; heating at least a portion of the first layer of the deposited polymeric material, using a directed heating element, to a temperature above the glass transition temperature of the polymeric material and below the melting temperature of the polymeric material; depositing on the heated portion of the first layer a second layer of polymeric material, while the heated portion of the first layer is above the glass transition temperature; heating at least a portion of the second layer of the deposited polymeric material, using the directed heating element, to a temperature above the glass transition temperature of the polymeric material and below the melting temperature of the polymeric material; depositing on the heated portion of the second layer a third layer of polymeric material, while the heated portion of the second layer is above the glass transition temperature; and repeating the above steps for each subsequent layer that is deposited on the preceding layer, where the portions of the current layer of polymeric material being deposited on are heated above the glass transition temperature and below the melting point.

The directed heating element can be a heating coil disposed annularly about the depositing head.

The polymeric material can further include a base material disposed therein.

In yet another embodiment, an additive manufacturing method comprising the steps of:

depositing on a surface, using a heated depositing head, a first layer of a metallic material; heating at least a portion of the first layer of the deposited metallic material, using a directed heating element, to a temperature range approximate to the current temperature of a subsequent layer of metallic material being deposited thereon, such that when the first layer and the subsequent layer cool, curling stresses between the layers are reduced; repeating the above steps for each subsequent layer that is deposited on the preceding layer, where the portions of the current layer of metallic material being deposited on are heated to a temperature range approximate to the current temperature of the present metallic material being deposited thereon, which forms the subsequent layer.

The directed heating element can include one or more lasers disposed about the depositing head.

The method or system embodiments above can also include using a temperature measurement device that measures the spot temperature of the previous layer along the path to adjust the power of the preheating energy source in real-time just prior to deposition of the subsequent layer (within a range) as to not over or under heat the prior layer.

The temperature measurement device that measures the spot temperature of the debound layer can also be used just prior to the layer becoming sintered or melted to adjust the power of the sintering or melting energy source in real-time to not over or under heat the process creating the perfect layer.

### BRIEF DESCRIPTION OF THE DRAWINGS

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

FIG. 1 Prior artⁱ, illustrates the steps of the BPD process.

FIG. 2A illustrates all steps of the BPD process combined into a single layer by layer process and an in situ temperature measurement using real-time feedback control to fine tune the heating elements throughout the process.

FIG. 2B illustrates the difference between a melted and sintered printed layer or part and in situ temperature measurement using real-time feedback control to fine tune the heating elements throughout the process.

FIGS. 2C-D Illustrates in situ temperature measurement and real-time feedback control adjustments to the heating elements.

FIG. 3 Illustrates various preheating, de-binding, sintering, and melting heat sources.

FIGS. 4A-B Illustrates a comparison of a first prior art process using three machines and multiple steps which can be reduced to two machines with the new invention and associated time savings.

FIGS. 5A-B Illustrates a comparison of a second prior art process which uses two machines which can be reduced to a single machine with the new invention and associated time savings.

FIG. 6 Illustrates a representative arrangement of a machine capable of performing each step of the IDM process.

FIGS. 7A-C Illustrates printing support material, base materials, multi-material and functionally graded material printed parts that can be created using the new invention.

FIGS. 8A-C Prior Art, illustrates various material deposition, material removal, and inspection tool heads that can be used within the new process.

FIG. 8D Illustrates a gantry style kinematic machine showing various tool heads that can be used together throughout the new process to deposit, sinter, melt, inspect, and remove excess material from a printed part.

FIG. 8E Illustrates a robotic arm kinematic machine with an end effector containing a material deposition head, thermal debinder, and a laser heat source.

FIG. 9 Illustrates the workflow process from software to printed part.

FIG. 10 Illustrates the comparisons between the new invention and state-of-the-art AM processes.

FIG. 11A-B Illustrates the benefits of the new invention.

### DETAILED DESCRIPTION

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “horizontal” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates.

A brief explanation of each of these four common processes are described below with their key limitations which are addressed by the new invention:

1. DED additive material processes are classified by the combination of their energy power source which is used to melt the material feedstock (i.e., laser, electron beam, plasma, electric arc) and the type of feedstock (wire or powder). This additive material process is performed by adding feedstock material into the melt pool which is formed by the energy source upon the substrate surface while being positioned with a kinematics system. The material cools and solidifies shortly after it is deposited forming the part one layer at a time.
a. Process Control: A significant challenge of the Laser-Wire DED process is that the feedstock material is added to the part being printed while it is being melted at high temperatures. This necessitates sophisticated control systems, real-time control, and or significant user intervention to create a successful printed part. Additionally, these processes are often not repeatable as the input variables wander, differ, interact and compound between builds of the exact same part.
b. Wire straightening: As the coiled wire feedstock unwinds and is fed into the deposition head the residual stresses in the wire are released inducing inconsistent curvature into the wire. This challenge impedes the ability to repeatability and precisely place the wire directly into the center of the melt pool created by the energy source.
c. Directionality: The angle formed between the wire and the part as wire is being fed into the melt pool changes relative to the travel direction between the part and the deposition head. For simplification, printing passes are often designed to occur in a single direction only which increases the print time and limits the complexity of the part able to be printed.
d. Surface flatness: Uniform surface flatness at each layer is extremely difficult to achieve on parts with non-uniform features and varying wall thicknesses primarily due to differing latent heat profiles which occur throughout non-uniform cross sections of the print. This energy needs to be considered and precisely balanced with the additional heat input required to melt the subsequent layer without overheating. Wire retractions and un-retractions at the beginning and end of each deposition pass also need to be synced precisely as the nozzle which directs the wire feedstock is not in direct contact with the substrate during the deposition process and therefore slight fluctuations in the wire feed are not as forgiving as they are in Material Extrusion processes.
e. Dripping, Wicking, and Stubbing: Passively controlling these parameters with machine code that is prepared prior to the print is extremely difficult due to variances in the aforementioned factors. For this reason, schemes are introduced to increase the wire feed on loss of contact or to pause the printing process to allow user operator intervention mid-print. These challenges not only make preparing and running the print difficult but also require constant user intervention to keep the printing process in control or resulting defects which are extremely difficult to recover from often requiring the print to be aborted.
f. Fine details: It is impractical to print fine detailed parts and lattice with wire due to the complexities mentioned above.

2. Laser-Powder DED processes are much more forgiving than Wire-DED processes but have the following challenges.
a. Material Inefficiency: Although some companies claim greater than 80% powder efficiency meaning that only 20% of the feedstock powder is not formed into the final printed part, the industry shows that 30-50% efficiency is more realistic. These inefficiencies significantly increase the material required and the cost of printing large parts.
b. Material Handling and Safety: Requires the operator to handle hazardous fine metal and ceramic powders when loading and cleaning the system.
c. Complex Control: Requires 3+ axis kinematic machines and control software to print parts with overhangs as the direction of material added to the part must be oriented with the gravitational vector throughout the entire print. This necessitates highly skilled personnel to program the tool paths, increasing the delivery timeline and costs of the printed part.
b. Print Feature Limitations: Unable to print fine lattice or features within fully enclosed volumes due to excess powder entrapment.
c. Output Limitations: Reduced machine output as layer thicknesses are generally limited to less than 60 microns in height.

3. Powder Bed Fusion processes deposit a flat layer of material (i.e., 35-60 micron layer thickness) across the build surface and then the heat source such as a laser or electron beam is used to selectively fuse the free powder where desired creating the solid part layer by layer. After the additive material process is complete the remaining free powder is then removed revealing the final part.
a. Cover Gas and Plume Management: In order to melt the powder consistently, a uniform distribution of cover gas is required across the entire build area to protect the melting powders from oxidation and to remove contaminants or the build quality will be compromised. Also, as the build volumes of PBF processes are scaled up in size (i.e. >1 cubic meter) gas control and plume management systems become significantly more complex to monitor and control.
b. Material Handling and Safety: Requires the operator to handle hazardous fine metal and ceramic powders when loading and cleaning the system otherwise costly powder handling management equipment is needed to add, remove, and recycle the powder.
c. Recoating: Recoating which occurs at every layer can be challenging due to collisions with the re-coater and the part that may occur if all processes such as the laser scan strategy, thermal balancing, and gas plume management are not within control. Holding layer flatness within the customary 30-to-60-micron range across build volumes greater than one square meter is also difficult.
d. Single Material: Powder bed processes and prints are limited to a single material which must also be used for both the build and support material.
e. High Material Cost: The PBF process requires the entire build volume to be filled with metallic powder to support the part as it is being printed. These costs increase significantly as the size of the PBF systems are scaled up and when printing with costly exotic material systems.

4. Bound Metal Deposition and Binder Jetting processes are only suitable for small metal parts (i.e., under 6-inches in diameter) with uniform cross sections limited by deformation stresses resulting from the de-binding and sintering processes. These are both multi-step AM processes requiring multiple machines for printing, de-binding, and sintering. This multi-step process often requires more than 24 hours to produce and finish a small part.

In some of these additive material processes, printing or fabricating with more than one material and/or composites is not yet possible. The present invention seeks to overcome many of the deficiencies presently existing in the aforementioned additive material fabrication processes. Some such advantages will be discussed in more detail below.

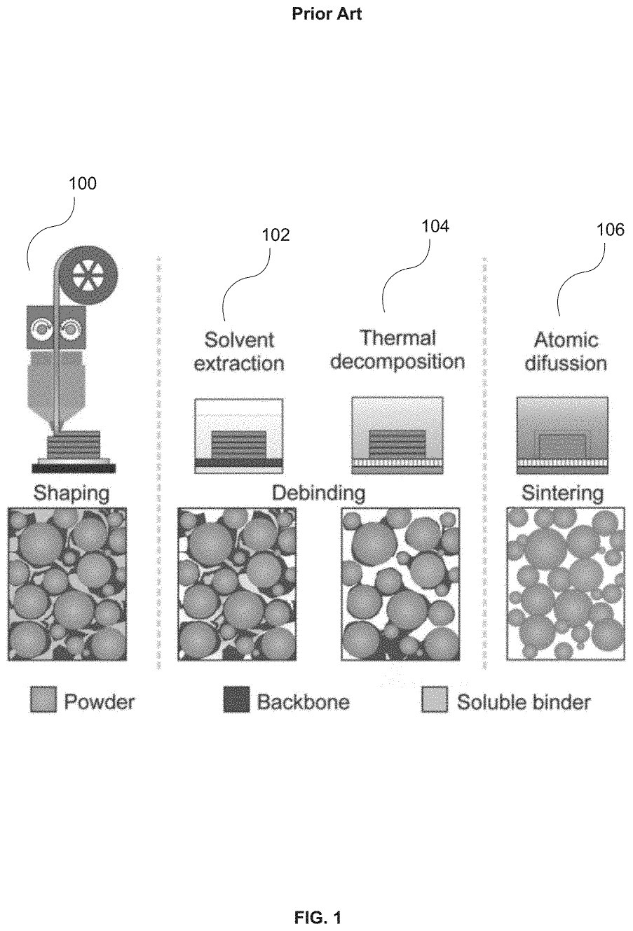

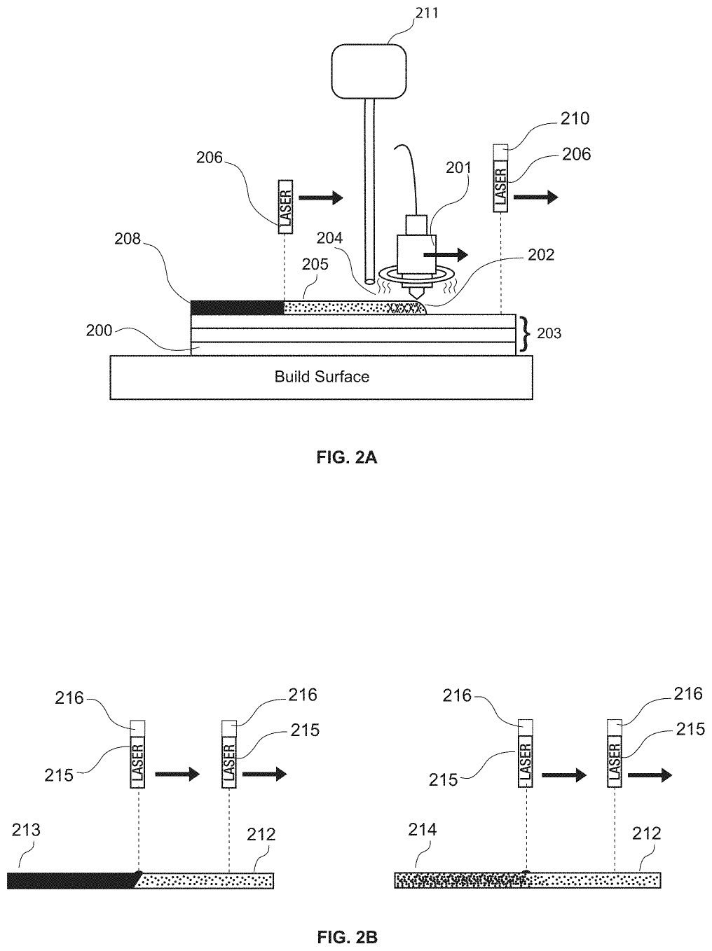

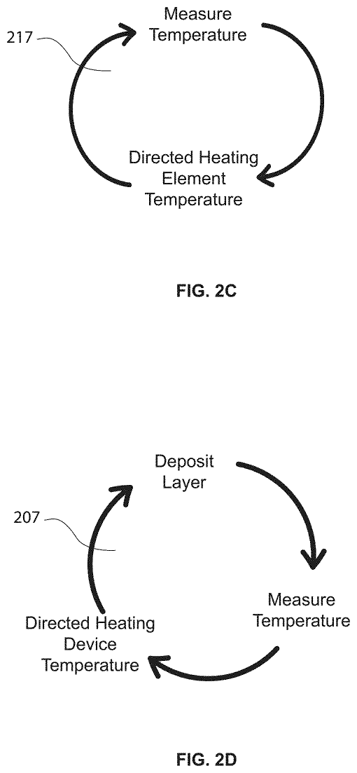

The present invention illustrated by the various embodiments combines (and eliminates) multiple steps of the Bound Powder Deposition (BPD) process as illustrated in FIG. 1 into a single Additive Manufacturing (AM) process as illustrated in FIG. 2 to improve print properties while decreasing both manufacturing times and associated costs.

BPD is a cost-effective AM process that uses Fused Filament Fabrication (FFF) to print both metallic and ceramic objects in the green state (or that which is pre-sintered material). Because FFF is the most widely used AM process, there are many benefits to using it to print metal and ceramic parts cost effectively. BPD has developed from the three step Metal Injection Molding (MIM) process in which a green part is molded from a composite material containing both metallic (or ceramic) powders and a polymeric binder. The binder is used to hold the part together until it is ready to be sintered. The part then undergoes a de-binding process in which the polymer is dissolved, decomposed, or outgassed out of the metal/polymer matrix creating what is known as the brown state or part. Lastly the brown part is sintered under heat creating the consolidated finished part. The finished part using the current state of the art is usually reduced in size (generally between 15-20%) from the printed green part.

The Bound Powder Deposition process illustrated in FIG. 1 uses the following steps to additively manufacture a metallic or ceramic part using the powder metallurgy process. The steps are:
1. Shape the part with the FE AM process 100.
2. Use a de-binding station to chemically 102 remove the primary polymeric binder from the part leaving only the base material and secondary binder also known as the backbone.
3. Thermally debind and decompose the secondary binder 104.
4. Use a high temperature heater to sinter the base material 106 creating the final part.

In some BPD processes such as BMD™ the material system is designed in such a manner as to eliminate the solvent extraction step only requiring the thermal decomposition step prior to sintering.

In the new improved process, known as In situ Deposition Melting (IDM) illustrated in FIG. 2A all three steps of the BPD process may occur in a single machine setting by selectively printing, de-binding and either melting or sintering the part throughout the printing process. Each step may occur simultaneously or serially at each printed layer 200 as the part is being printed.
1. The deposition head 201 deposits the green material 202 while building up the part 203 layer by layer.
2. Energy from a heat source removes the binders by thermally degrading the organic, inorganic, polymeric, or liquid binder 204 from the base metallic or ceramic powder material creating the debound brown state 205.
3. The heat source such as a laser 206 sinters or melts the base material creating the final solid part 208.

An integrated thermal camera 210 or infrared pyrometer can be used to measure the temperature of the previous layer just prior to deposition of the subsequent layer to finely tune the induced thermal energy via a real-time feedback control loop 207, as shown in FIG. 2C. FIG. 2D illustrates another feedback loop 217 where the directed heating device can be updated in real-time based on the measured temperature. This applies to the de-binding process as well as to the preheating, melting and sintering processes.

A gas and particle ventilation system including a vacuum inlet 211 may be directed at the portion of the first or second layer where the thermally removing process step is occurring to remove the sublimated particulates.

In a melted metal part illustrated in FIG. 2B the laser 215 is shown de-binding the base material 212 which is fully melted 213 together creating a solid part. Wherein a sintered part undergoes a lower temperature solid state diffusion process 214 wherein the powders are bound together without liquefaction creating a solid part. Sintering temperatures are generally 15 to 20% less than the melting temperature of the base material. An integrated thermal camera 216 or infrared pyrometer can be used to measure the temperature and make real-time adjustments during the debinding, melting and sintering processes.

The directed heating device, such as the laser 215, can follow the path of material being laid down by the depositing head. This can be offset by a few millimeters to several inches based on the thickness of the layer, type of material being used and the geometry of the part. As noted, the directed heating device can be directly attached to the depositing head or be a stand-alone device, having multiple axis of freedom to move. Mechanisms that enable multiple axis of freedom are known in the art.

The directed heating device can heat in ranges from 40-600 Celsius, depending on material, during the de-binding process, and range from 400-2200 Celsius during the melting or sintering range for many materials. Some specialty materials can have higher melting or sintering temperatures in the 3600 Celsius ranges, such as Tungsten. Depending on the directed heating device, this temperature could be accomplished with a single device or a combination of multiple directed heating devices.

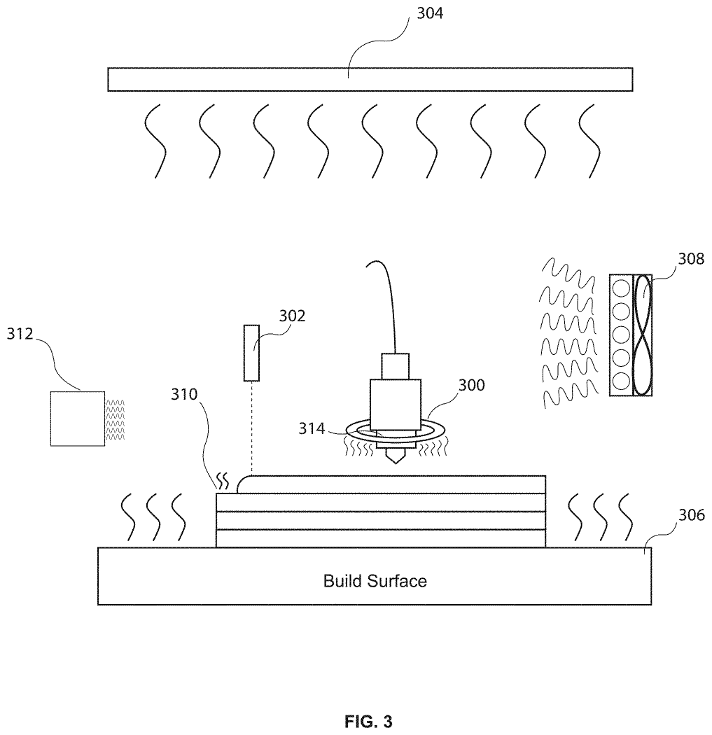

Various heat source combinations can be used to drive off the binder from the base material as well as to preheat, sinter, and melt the layers as illustrated in FIG. 3 throughout the printing process. These may include an annular heating element 300, lasers 302, radiant heaters 304, resistive heaters 306, convection heaters 308, latent heat from the previous layer 310, and microwave 312. It should be noted that though resistive heaters 306 can assist, it is generally not targeted enough and if placed underneath the build surface cannot affect the layers as other directed heating devices can, and in a manner that targets portions of the layer and individual layers. An insulator 314 can be used to inhibit any external heat sources from interfering with the temperature of the deposition nozzle which must be highly controlled throughout the printing process. Due to the wide band of thermal transfer characteristics among materials and geometries more than one directed heat source can be utilized within the methods and systems described herein. For example, larger parts might require more power over a broader surface, while smaller parts with varying materials may require less energy that is more focused and tuned to a specific wavelength or power, which can help achieve the desired de-binding or sintering of the specific portion or layer or feature.

It should be noted that when the previous layers are preheated, that helps to remove residual stresses, which decreases distortion strain while increasing the bonding strength between each layer when printing with polymers, metal, ceramic, and composite systems. This is a result of being able to utilize directed heating devices.

Preheating the previous layer using a directed heating device can assist when binding, for example, a previously laid layer of metal to a metal layer being currently deposited thereon.

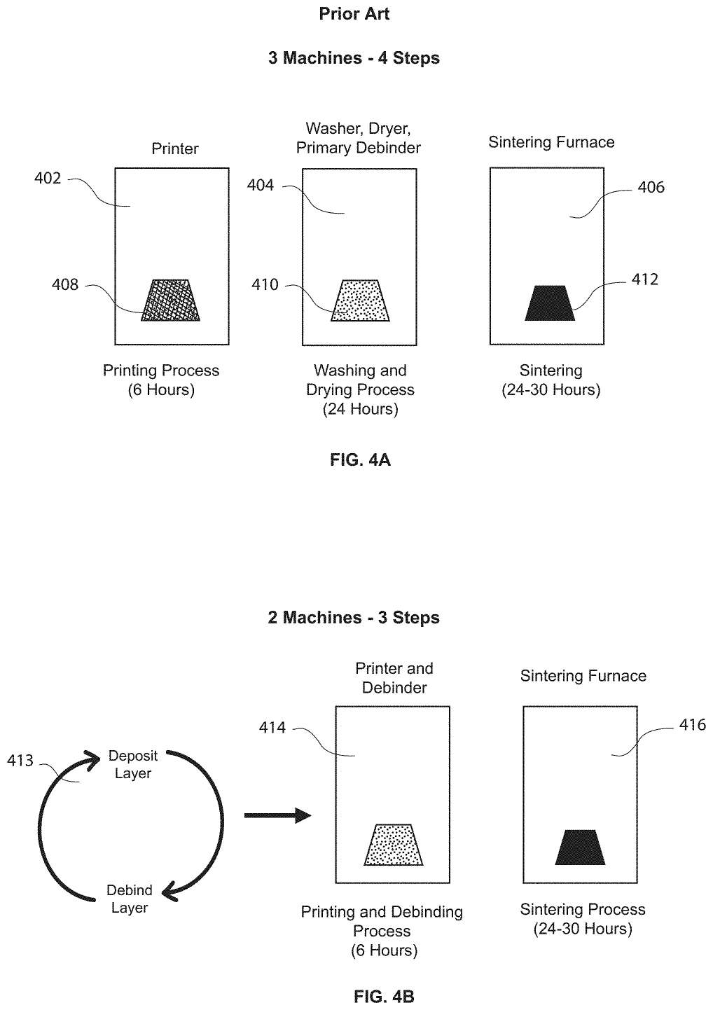

Significant industry advantages can also be achieved by combining only the printing and de-binding steps into a single machine as illustrated in FIGS. 4A-B. A commercially available BPE system currently sold by Markforged is the Metal X system which contains three machines and four processes as illustrated in FIG. 4A namely the Printer 402 which prints the green part 408, the washer 404 which removes the primary binder from the printed green part 410, and the de-binding and sintering furnace 406 which creates the final sintered part 412.

This system can be improved upon by modifying the feedstock material to allow it to thermally debind and by adding a heat source to the printer to debind the part between printed layers 413. This eliminates the washing and drying steps and machine from the Metal X system as illustrated in FIG. 4B wherein the printer 414 creates the brown part prior to it being sintered in a sintering furnace 416. Such advances will reduce the cycle time of more than 24 hours by removing the washing step allowing the brown part to be debound before it enters the sintering furnace. A near fully debound part can also decrease the required sintering time in the furnace which is advantageous as the sintering furnace is generally the bottleneck of the BPD process. Additionally induced residual stresses resulting from shrinking during the de-binding and sintering steps are further reduced as the binder is removed at each layer also mitigating entrapped binder gases which cause printed parts to crack or explode. This increases overall reliability of the system as well as increasing the BPE printed part success rate while allowing larger and more complex parts to be produced. An additional benefit of using an annular heating element is that omni-directional heating occurs normal to the deposited material which can be beneficial by providing multiple de-binding passes to the previously printed layers as the heating element both leads and trails the deposition nozzle.

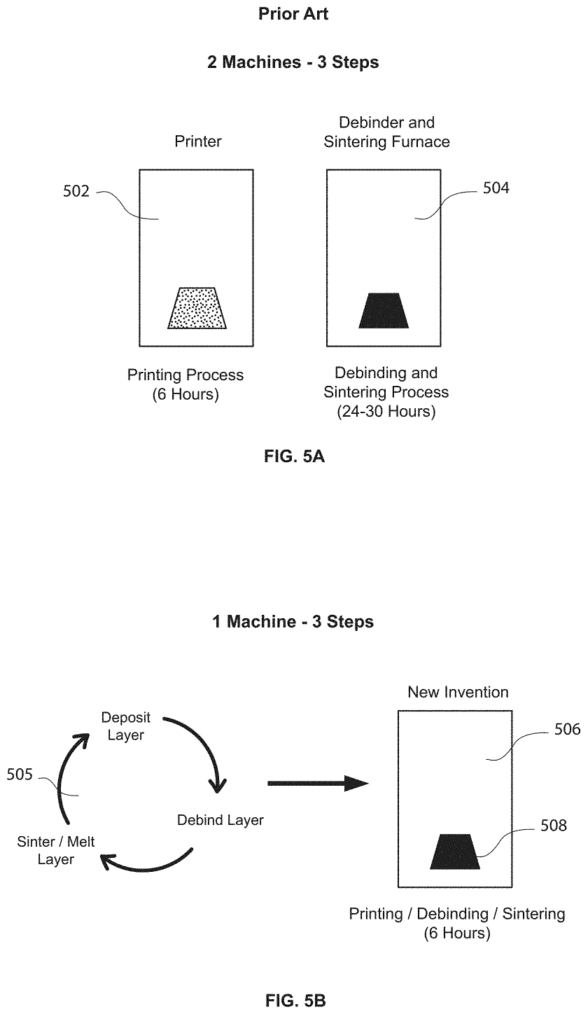

The commercially available Desktop Metal Studio System using the BMD™ process illustrated in FIG. 5A uses two machines and three processes to create a printed part. Similar to the BPE process the green part is printed in the printer 502 but differentiating in that it is thermally debound and sintered in the sintering furnace 504. By implementing the full IDM process as shown in FIG. 5B, the de-binding and sintering furnace and separate sintering process can be eliminated, reducing the three-step process to a single machine 506 and saving a minimum of 24 hours of sintering time currently required to sinter the representative part 508.

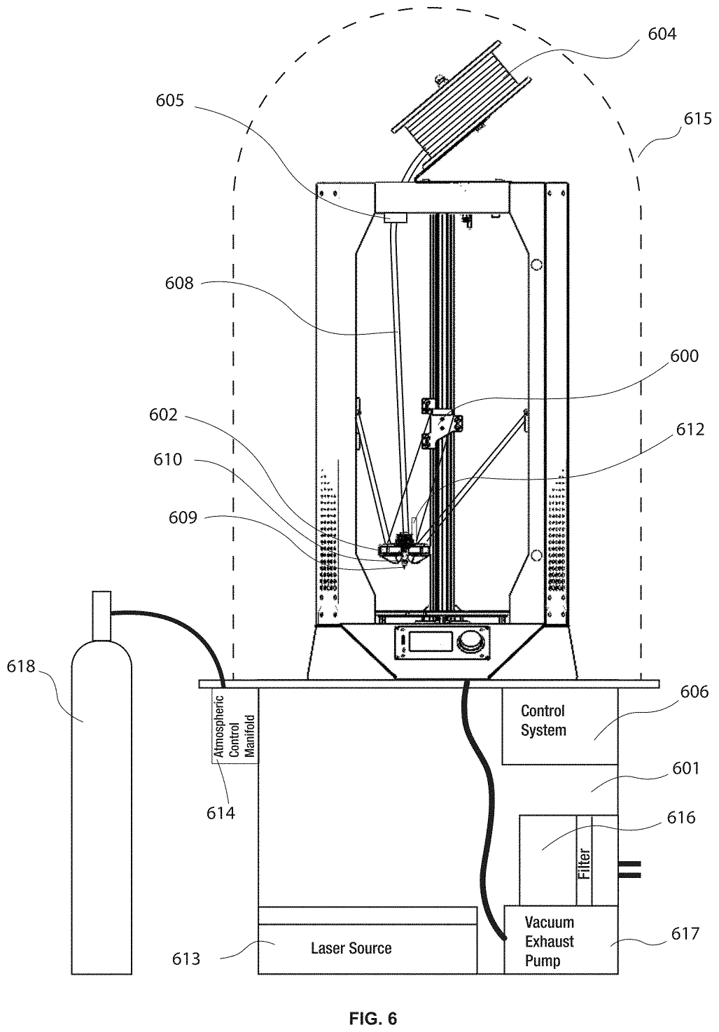

An example of an IDM machine is illustrated in FIG. 6 wherein all three steps of the IDM process 505 occur within a single machine. In this arrangement delta style kinematics 600, control 601 the placement of the end effector 602 which guides the deposition head 603 to deposit the printed layer paths. Spooled bound powder filament feedstock 604 is driven by the filament extruder 605 as controlled by the control system 606 through the filament guide tube 608 which forces extrusion through the nozzle 609 of the heated deposition head 610.

A low power or diffused laser 612 either tracks the deposition process thermally de-binding the deposited material or it de-binds the deposited layer in a subsequent pass. A third higher power pass of the same laser or a secondary laser source 613 then fully sinters or melts the debound layer of material creating the printed part.

A controlled 614 atmospheric chamber 615 or enclosure is used to remove volatiles and contaminants 616 from the de-binding process as well as free oxygen atoms to prevent further oxides from forming during the sintering and melting processes. Certain embodiments of IDM may occur under ambient atmospheric conditions and temperatures or within a heated chamber which may also include a vacuum atmosphere 617 to aid in driving out and removing the binder. In some cases, the IDM process is recommended to run within a pressurized chamber to improve powder consolidation resulting in higher part densities. Achieving full density greater than 97% is important as the mechanical performance of a print is proportional to its density. Combinations of inert gas 618 atmospheres (i.e., argon, nitrogen and specialty gas mixes) may be used to reduce oxidation throughout the build process depending on what base and binder material systems are being used to create the printed part. Often times it is desired to have less than 50 ppm O2 when sintering parts. Reduce atmosphere can also improve the printing, de-binding and sintering processes.

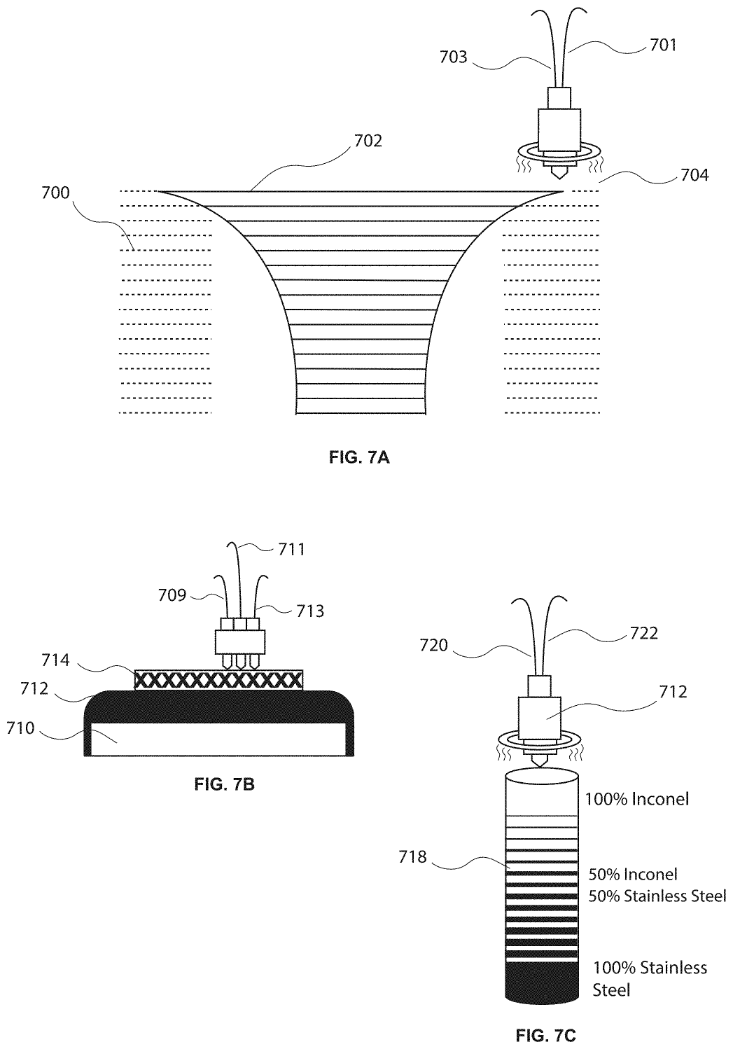

The invention allows for multiple materials to be printed, sintered, and melted all within the same process as illustrated in FIGS. 7A-C. This is beneficial when printing temporary support setters 700 from support feedstock 701 to support the base material 702 printed from the base feedstock 703 throughout the printing, de-binding, and sintering or melting process. The annular heating element, laser or other heat source can also cure or set 704 the support material in place throughout the printing process without adding any additional processing time.

Printing and bonding of various materials with differing melt characteristics and temperatures within a single printed part is also possible with the new invention. This is not possible in current BPD and MIM processes as this would require that each composite material has a similar sintering temperature profile. A sintering furnace cannot discriminately heat multiple composite materials at different temperatures. Such an act would also cause differential shrinking between the materials due to their varying coefficients of thermal expansion which leads to weak bonding, stress fractures and breaking. An example of a tri-metallic printed piece using this process is shown being printed from a stainless-steel 709, copper 711, and tungsten carbide 713 feedstocks having comprised of three discrete material systems namely, a corrosion resistant stainless-steel base 710 that has been created by fully melting a stainless-steel powder using the IDM process which is enveloped within a highly thermal conductive copper cladding 712 and capped with a sintered hardened tungsten carbide 714 abrasion resistant upper surface.

Functionally graded printed parts can also be made with the new process by adding and mixing multiple material feedstocks prior to their entering the deposition head 712 such as Inconel 720 and stainless steel 722. An example of a printed stainless-steel cylinder that gradually blends into an Inconel cylinder is depicted in 718.

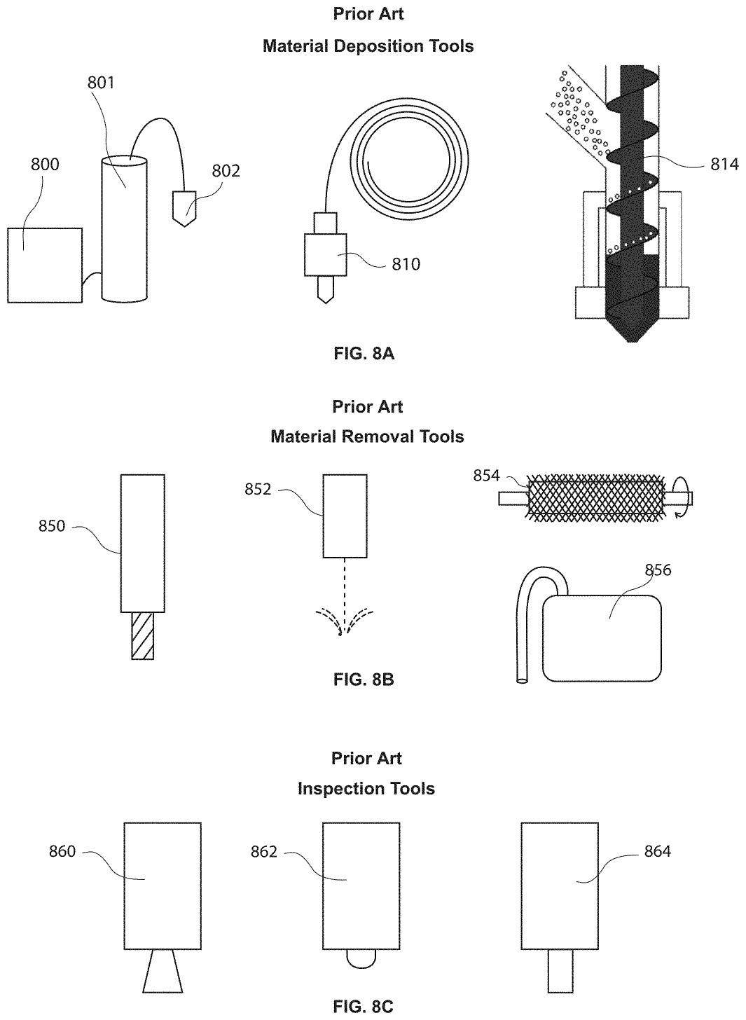

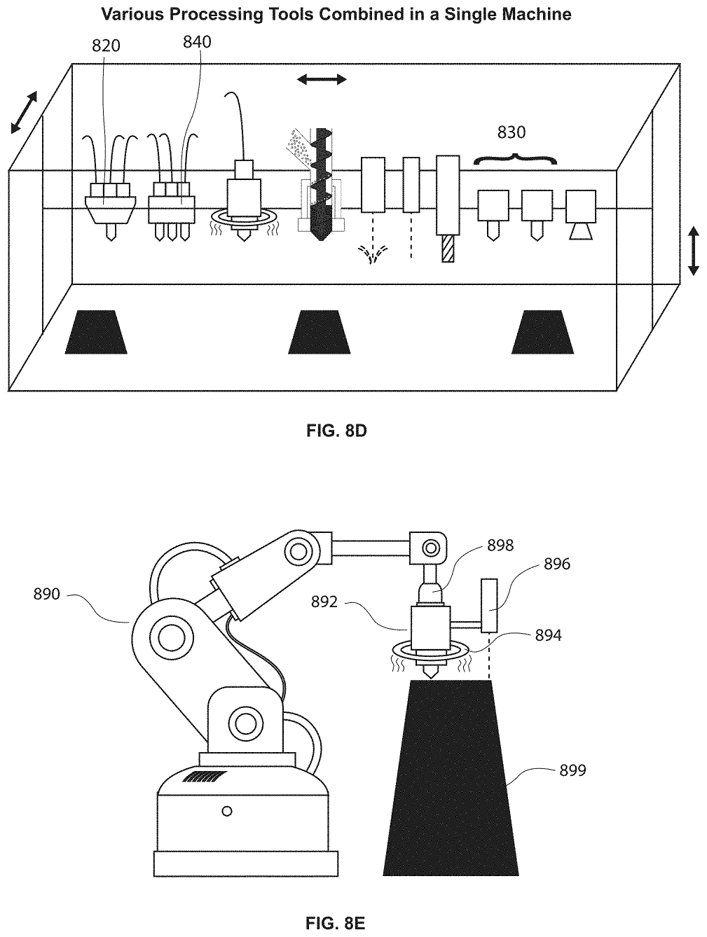

Additive as illustrated in FIG. 8A, Subtractive as illustrated in FIG. 8B, and Inspection as illustrated in FIG. 8C processes can all be combined within the IDM process as illustrated in FIG. 8A-D. Additive deposition processes such as a paste extruder where a pump is used 800 to pump the base binder composite from a material reservoir 801 which is then extruded through a paste deposition nozzle 802, or a filament extruder 810 extrudes one or more filaments through the deposition head and nozzle assembly and or a screw extruder 814 extrudes resin, pellet or granules via the force of a rotating screw. Each of these processes can all occur at low or elevated temperature depending upon the characteristics of the material system. It will also be appreciated that the various deposition tools may be separated 830, or combined 840 within the same deposition head having separate nozzles or joined within a single deposition head sharing a common deposition nozzle 820.

Subtractive material removal tools such as a cutting mill 850 laser ablation 852 or a static or spinning wire brush 854 can be used to remove base material, contaminants and oxides and a vacuum 856 can be used to remove loose material throughout the IDM process.

Inspection tools such as cameras 860, pyrometers 862, and profilometers 864 can be used in the IDM process to monitor, capture, and record the IDM process conditions while also being fed into the controller for improved real time process control.

All of the processing tools can be controlled kinematically by a delta robot as previously illustrated, by a gantry as illustrated in FIG. 8D showing various tool heads which can be used together throughout the new process to deposit, sinter, melt, inspect, and remove excess material from a printed part or by a robotic arm 890 as illustrated in FIG. 8E with a material deposition head 892, a thermal debinding element 894, and a laser 896 attached to the end effector 898 to perform the IDM process to print a large component 899.

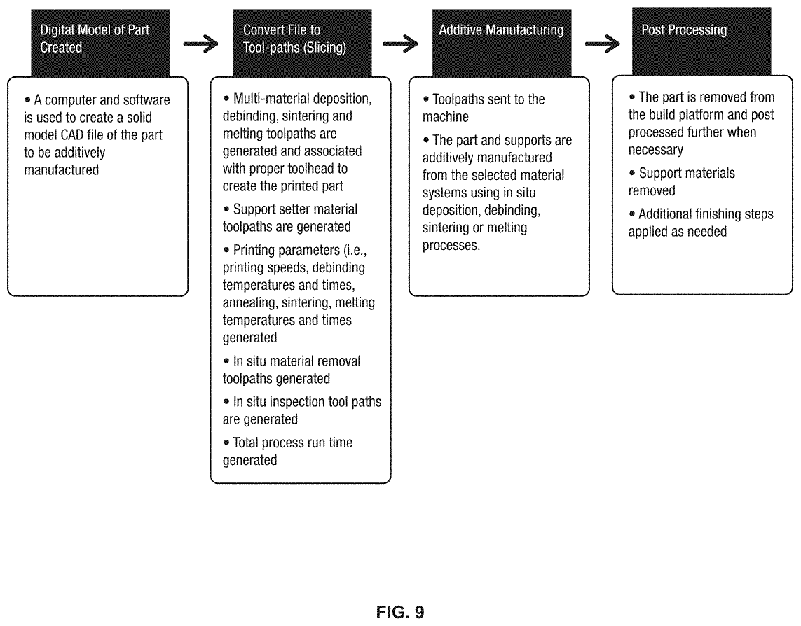

The IDM workflow process from software to printed part is illustrated in FIG. 9.

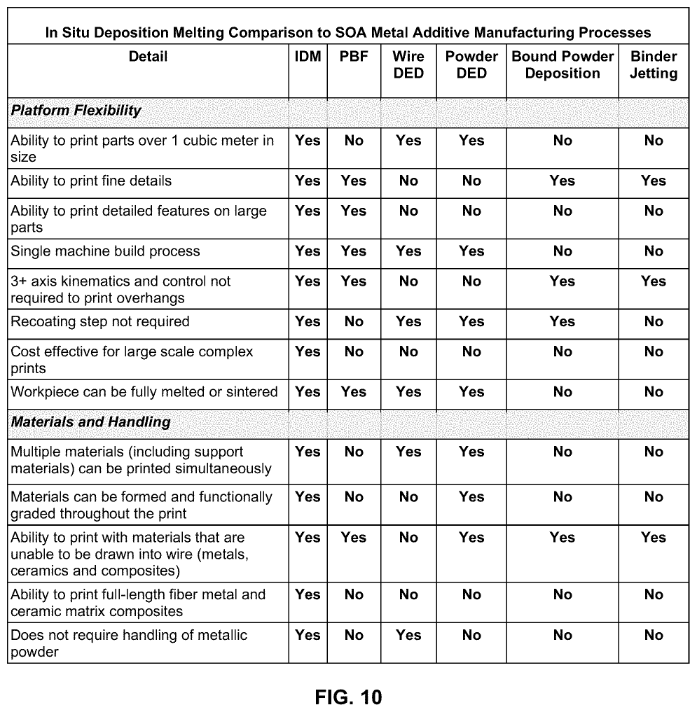

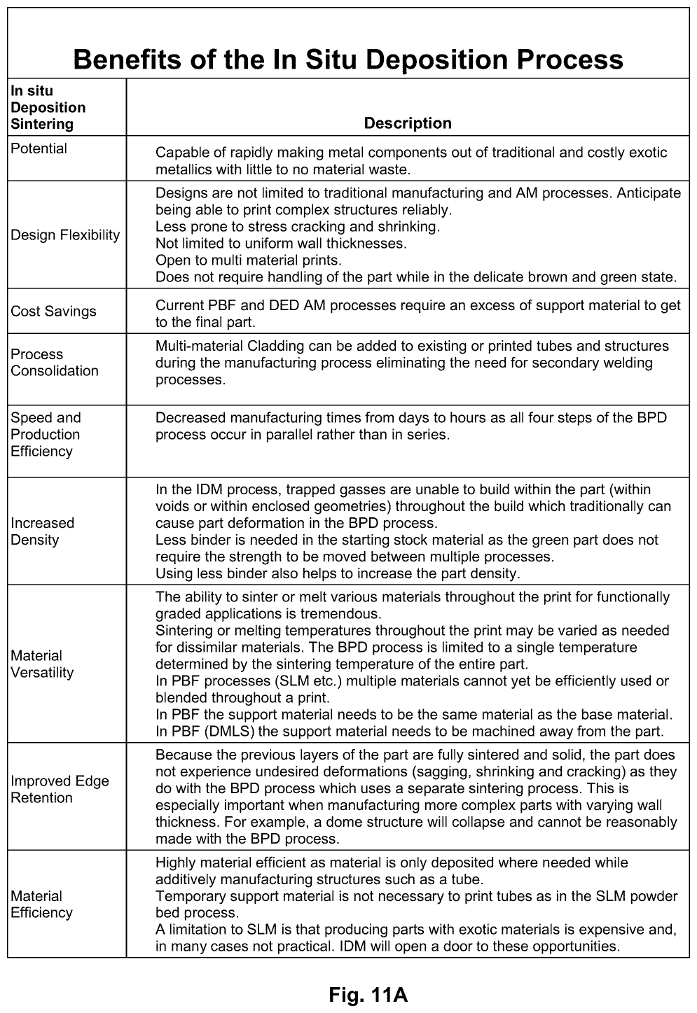

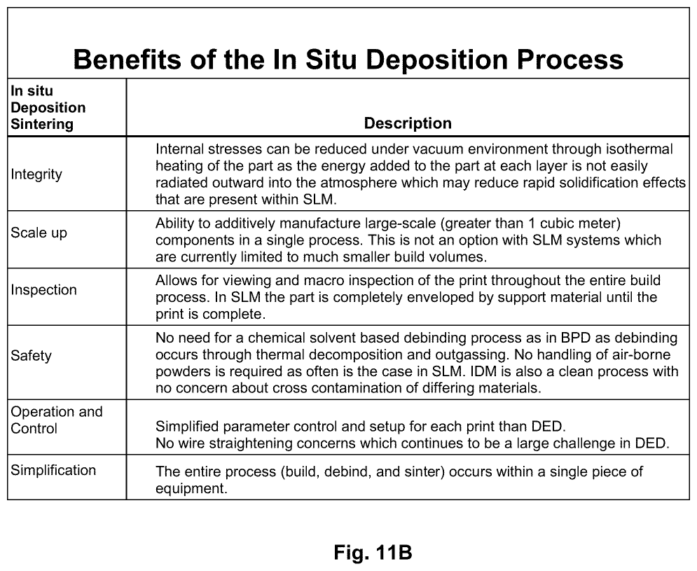

A comparison chart of the IDM versus current additive manufacturing processes is illustrated in FIG. 10, which conveys a lot of the differences and advantages of this disclosed process over that in the field.

FIGS. 11A-B illustrates additional benefits of the invention described herein.

It will be further appreciated that these processes and methods discussed herein can be performed in an enclosed chamber, controlled environments, temperatures, pressure, inert gases, open-air etc.

Regarding composite materials, it should be noted the composite materials can be provided initially in several different forms include a spooled solid string, paste, slurry, or formable manner. Having a heated deposited nozzle can aid in the extruding process.

The composite materials can have a base component that has greater than 50% by weight a final material, such as ceramic or metal, to remain after de-binding and possibly additional melting or sintering. The weight can be greater than 60%, 70%, 80% or even 90% for the base component. The primary binding component of the composite material, depending on the density, can have a volume less than 20%, less than 15%, less than 10% or even less than 5%. Once removed through the techniques described above, the resulting volume of the layers and overall part can be limited to being reduced by less than 20%, less than 15%, less than 10% or even less than 5% by volume. If not stated explicitly, one advantage of controlling the overall shrinkage of the part and in more particular, each layer, is that higher accuracy and more precise parts can be created, in a manner that is faster than previous methodologies.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Further, discussion with regard to any of the specific features is intended to be for illustrative purposes, with the understanding that any feature discussed herein can be used in combination with any number of other features in any combination. Accordingly, it is not intended that the invention be limited by virtue of the necessity of discussing exemplary embodiments thereof.

Those skilled in the art will recognize improvements and modifications to the preferred embodiments of the present disclosure. All such improvements and modifications are considered within the scope of the concepts disclosed herein and the claims that follow. Additionally, any steps or processes discussed herein are not intended to be restrictive with regard to a particular sequence and those having skill in the art will recognize where certain steps may be performed in various alternative sequences.

ⁱImage Credit:
Sapkota, Janak. Schematic representation of the shaping, debinding, and sintering (SDS) process. ResearchGate. Materials (MDPI). https://www.researchgate.net/publication/325266287/figure/-fig3/AS:718152023412743@1548232193545/Schennatic-representation-of-the-shaping-debinding-and-sintering-SDS-process-and.png

1. An additive manufacturing process method comprising the steps of:
depositing on a surface, using a depositing head, a first layer of a bound composite material comprised of a primary binding component and a base component;
thermally removing, using a directed heating device, at least 50% of the primary binding component from the deposited composite material;
depositing on the first layer, using the depositing head, a second layer of the composite material; and
thermally removing, using a directed heating device, at least 50% of the primary binding component from the deposited composite material in the second layer.

2. The additive manufacturing process method of claim 1, wherein the directed heating device is configured to follow the path of the deposited composite material for each layer deposited.

3. The additive manufacturing process method of claim 2, wherein the directed heating device is comprised of a laser, heating coil or solid-state device.

4. The additive manufacturing process method of claim 1, further comprising the step of melting or sintering the remaining base component of each deposited layer after each step of thermally removing at least 50% of the primary binding component is performed.

5. The additive manufacturing process method of claim 4, wherein the melting or sintering step is performed by the same directed heating device.

6. The additive manufacturing process method of claim 1, wherein the base component of the composite material is comprised of one of the following: powdered metal, powdered ceramic, metal fibers, and ceramic fibers.

7. The additive manufacturing process method of claim 1, wherein the primary binding component has a melting temperature below that of the base component.

8. The additive manufacturing process method of claim 1, further comprising the step of drawing away gas and particles generated from the thermally removing steps, using a gas and particle ventilation system.

9. The additive manufacturing process method of claim 8, wherein the gas and particle ventilation system includes a vacuum having an inlet directed at the portion of the first or second layer where the thermally removing process step is occurring.

10. The additive manufacturing process method of claim 1, further comprising the step of sensing, using a non-contact temperature sensor, the temperature of the first layer prior to thermally removing material.

11. The additive manufacturing process method of claim 10, wherein the output of the directed heating device is based on the measured temperate acquired from the non-contact temperature sensor.

12. The additive manufacturing process method of claim 1, further comprising the step of enclosing the area around where the first and second layers are being formed and filling the area with an inert gas.

13. The additive manufacturing process method of claim 1, further comprising the step of reducing the atmosphere about a volume encompassing at least a portion of the first and second layers.

14. An additive manufacturing system comprising:
a heated deposition head configured to precisely position on a build surface layers of a bound composite material formed of a primary binding component and a base material, wherein the heated deposition head is part of a 3-D printing system;
a directed heating element that is configured to follow the path of the deposited bound composite material and wherein the directed heating element has at least two heating settings, a first heat setting configured to thermally remove the primary binding component from the deposited bound composite material and a second heat setting configured to melt or sinter the remaining base material;
a controller configured to operate the heated deposition head and the directed heating element, wherein the controller is configured to receive instructions to build a component using the bound composite material, wherein the instructions include the speed and placement of the materials for the depositing head, as well as the speed and temperature setting for the directed heating element; and
a vacuum exhaust system.

15. The additive manufacturing system of claim 14, further comprising an enclosure disposed about the build surface, wherein the enclosure is configured to receive from an atmospheric control manifold a gas used during a de-binding phase where the directed heating element is operating at a first temperature setting as well as during a melting or sintering phase where the directed heating element is operating a second temperature.

16. An additive manufacturing method comprising the steps of:
depositing on a surface, using a heated depositing head, a first layer of a polymeric material;
heating at least a portion of the first layer of the deposited polymeric material, using a directed heating element, to a temperature above the glass transition temperature of the polymeric material and below the melting temperature of the polymeric material;
depositing on the heated portion of the first layer a second layer of polymeric material, while the heated portion of the first layer is above the glass transition temperature;
heating at least a portion of the second layer of the deposited polymeric material, using the directed heating element, to a temperature above the glass transition temperature of the polymeric material and below the melting temperature of the polymeric material;
depositing on the heated portion of the second layer a third layer of polymeric material, while the heated portion of the second layer is above the glass transition temperature; and
repeating the above steps for each subsequent layer that is deposited on the preceding layer, where the portions of the current layer of polymeric material being deposited on are heated above the glass transition temperature and below the melting point.

17. The additive manufacturing method of claim 16, wherein the directed heating element is a heating coil disposed annularly about the depositing head.

18. The additive manufacturing method of claim 16, wherein the polymeric material further includes a base material disposed therein.

19. (canceled)

20. (canceled)
